(19) United States
(12) Patent Application Publication
(10) Pub. No.: US 2013/0166860 A1
(43) Pub. Date: Jun. 27, 2013

(54) MEMORY ACCESS CONTROL DEVICE AND COMPUTER SYSTEM

(71) Applicant: Fujitsu Limited, Kawasaki-shi (JP)

(72) Inventors: Takeshi OWAKI, Kawasaki (JP); Takaharu Ishizuka, Kawasaki (JP); Hiroshi Kawano, Kawasaki (JP); Keita Kitago, Kawasaki (JP); Atsushi Morosawa, Kawasaki (JP)

(73) Assignee: Fujitsu Limited, Kawasaki-shi (JP)

(21) Appl. No.: 13/772,433

(22) Filed: Feb. 21, 2013

Related U.S. Application Data
(63) Continuation of application No. PCT/JP2010/065836, filed on Sep. 14, 2010.

(51) Int. Cl. G06F 12/06

(52) U.S. Cl. CPC G06F 12/0607
USPC 711/157

(57) ABSTRACT

A memory interleaving device accesses a memory in an interleaved manner for changing the number of ways of interleaving during system operation. During a copy which changes a first configuration before changing the number of ways in the interleaving to a second configuration after changing the number of ways in the interleaving, a memory access control device reads the memory in the first configuration before changing the number of ways of the interleaving for an external read request and writes the memory in both of the first configuration before changing the number of ways in the interleaving and the second configuration after changing the number of ways in the interleaving for an external write request.

### CROSS-REFERENCE TO RELATED APPLICATION

This application is a continuation application of International Application PCT/JP2010/065836 filed on Sep. 14, 2010 and designated the U.S., the entire contents of which are incorporated herein by reference.

### FIELD

The embodiments discussed herein are related to a memory access control device and a computer system.

### BACKGROUND

The computer system has been used as a data processing apparatus, an image processing apparatus, an audio apparatus or the like. With an increase of capabilities and functions of the computer system, the storage device (hereinafter referred to as memory) is used in large quantities in the computer system. A memory interleaving method is known as a technique to speed up memory access.

In the memory interleaving method, data is divided into N pieces of blocks, and each of blocks is written to different memories and is read from the different memories. In other words, it is possible to write and read data in parallel, thereby it is effective to speed up memory access. The number of division is called as the number of way.

In the memory interleaving method, the large number of way contributes to speed up memory access. Therefore, there is a case to change the number of way once set. For example, after turning on a power of a system, by checking the status with the memory, to determine the number of interleaving Way, set the memory map according to the number Way determined to carry out the start of the OS in accordance with the memory map. In addition, according to the remaining amount of power (battery), interleaving ratio adjusts the read/writes (number of concurrent access).

### RELATED ART

Japanese Laid-open Patent Publication No. Hei 8-044624,

Japanese Laid-open Patent Publication No. 2007-193810,

Japanese Laid-open Patent Publication No. 2008-310465.

However, in order to carry out the change of way, it becomes necessary to restart the system. In addition, the method of adjusting the number of simultaneous accesses, it is difficult to increase or decrease the number of memory modules in the system during the operation. That is, it was a problem to increase operating costs and emissions of carbon dioxide (CO 2) associated with the increase in power consumption, but it is difficult to optimize the resources with proportional to request processing in operation.

### SUMMARY

According to an aspect of the embodiments, a memory access control device which interleaves a memory having a plurality of memory circuits and performs read and write access, includes a plurality of ports which are connected to the plurality of memory circuits of the memory and a port access control circuit which receives a memory request from an external and performs read or write access to the memory circuit via the plurality of ports in accordance with the number of interleave ways which is set, and the port access control circuit, in accordance with an instruction to change the number of interleave ways, copies data on a position of the memory in a configuration before changing the number of interleave ways to a position of the memory in a configuration after changing the number of interleave ways, and performs the read access to the memory according to the configuration before changing the number of interleave ways for a read request from the external and performs the write access to the memory according to the configurations before and after changing the number of interleave ways for a write requests from the external, during the copy.

According to another aspect of the embodiments, a computer system includes a processing unit, a memory having a plurality of memory circuits, a plurality of ports which are connected to the plurality of memory circuits of the memory and a port access control circuit which receives a memory request from an external and performs read or write access to the memory circuit via the plurality of ports in accordance with the number of interleave ways which is set, and the port access control circuit, in accordance with an instruction to change the number of interleave ways, copies data on a position of the memory in a configuration before changing the number of interleave ways to a position of the memory in a configuration after changing the number of interleave ways, and performs the read access to the memory according to the configuration before changing the number of interleave ways for a read request from the external and performs the write access to the memory according to the configurations before and after changing the number of interleave ways for a write requests from the external, during the copy.

The object and advantages of the invention will be realized and attained by means of the elements and combinations part particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a computer system according to an embodiment;

FIG. 2 is an explanatory diagram of the process of increasing the number of ways of interleaving according to the embodiment;

FIG. 3 is an explanatory diagram of the process of reducing the number of ways of interleaving according to the embodiment;

FIG. 4 is an explanatory diagram of the memory access during a configuration change according to the embodiment;

FIG. 5 is a block diagram of a memory access control device according to the embodiment;

FIG. 6 is an explanatory diagram of ports and memory module group in FIG. 1 and FIG. 2;

FIG. 7 is a flow diagram of the entire process of change in the number of interleaved way according to the embodiment;

FIG. 8 is a time chart of each part of the changing process in FIG. 7;

FIG. 9 is a detailed flow diagram of the change process in FIG. 6;

FIG. 10 is an explanatory diagram of a memory map of an OS before the change in the number of interleaving;

FIG. 11 is an explanatory diagram of a memory map of the OS during the change in the number of interleaved; and

FIG. 12 is an explanatory diagram of a memory map of the OS after changing the number of interleaved.

### DESCRIPTION OF EMBODIMENTS

Hereinafter, embodiments will be described in order of a computer system, change operation of the number of interleaved way, a memory access controller, a process of change of the number of interleaved way, other embodiments, but the disclosed computer system, memory, memory access controller are not limited to the embodiments.

(Computer System)

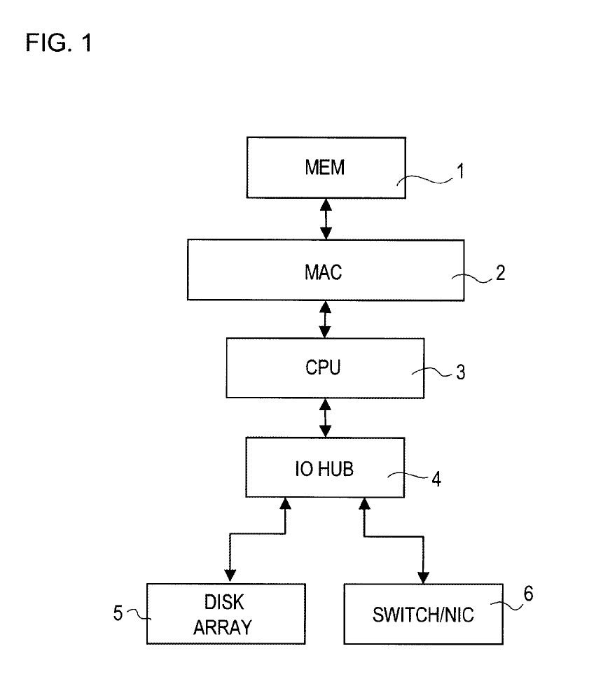

FIG. 1 is a block diagram of a computer system according to an embodiment. FIG. 1 illustrates a server as a computer system, for example. As illustrated as FIG. 1, the server includes an arithmetic processing unit (CPU: Central Processing Unit) 3, a memory access controller 2 and a memory 1.

The arithmetic processing unit (hereinafter referred to as CPU) 3 performs read and write access from and to the memory 1 via the memory access controller (hereinafter referred to as the memory access control circuit) 2, reads data, performs a desired processing, and writes a result of the processing to the memory 1. In the embodiment, the memory 1 is composed of a plurality of memory modules. The memory 1 preferably is used RAM (Random Access Memory), and the memory 1 may be used any of DRAM (Dynamic Random Access Memory) and SRAM (Static Random Access Memory). The memory access control circuit 2 receives read and write commands and memory address from the CPU, and performs read and write data to the corresponding address location of the memory module in the memory 1 according to the number of ways which is set.

The CPU 3 connects to an IO hub (Input/Output Hub) 4. The IO hub 4 connects to storage apparatus 5 as an external device, and a switch/network interface card (NIC: Network Interface Card) 6.

The CPU 3 performs the read and write access to the storage apparatus 5 via the IO hub 4. In the embodiment, the storage apparatus 5 is composed of a disk array device. The disk array storage device is a storage device with a large capacity.

In addition, the CPU 3 connects to the switch 6 through the IO hub 4. The switch 6 connects to the other server. Therefore, the CPU 3 communicates with other servers via the IO hub 4 and the switch 6. The CPU 3 connects to a network via the IO hub 4 and the network interface card 6. Therefore, the CPU3 communicates with an external device.

In the computer system, the memory access control circuit 2 performs the read and write access to the memory 1 which is composed of a plurality of memory modules according to the number of way which is set. It is effective to change the number of way during operation.

For example, when increasing the number of memory modules which can be used such as installing additional memory modules and turning on a power on the memory module which has been turned off the power, there is an increase of the number of ways that can be used. It is referred to Hot Add of the memory to increase the memory modules that can be used during operation. When the number of ways that can be used is increased, it is possible to speed up memory access by increasing the number of ways of interleaving.

On the contrary, when the memory access speed is in excess or the amount of memory has become excessive, the number of ways of interleaving is decreased. Therefore, it is possible to reduce power consumption of the memory accesses by performing to turn of the power to the excessive memory module (called as Hot Remove).

(Operation of Change in the Number of Interleaved Way)

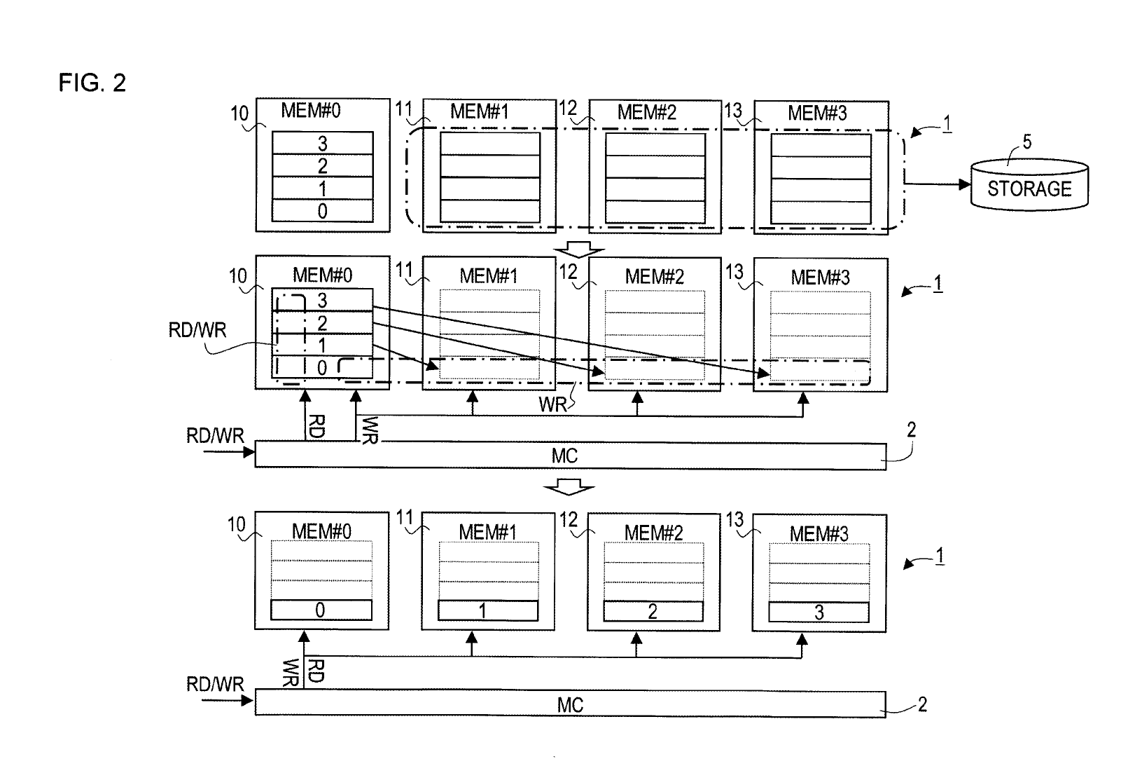

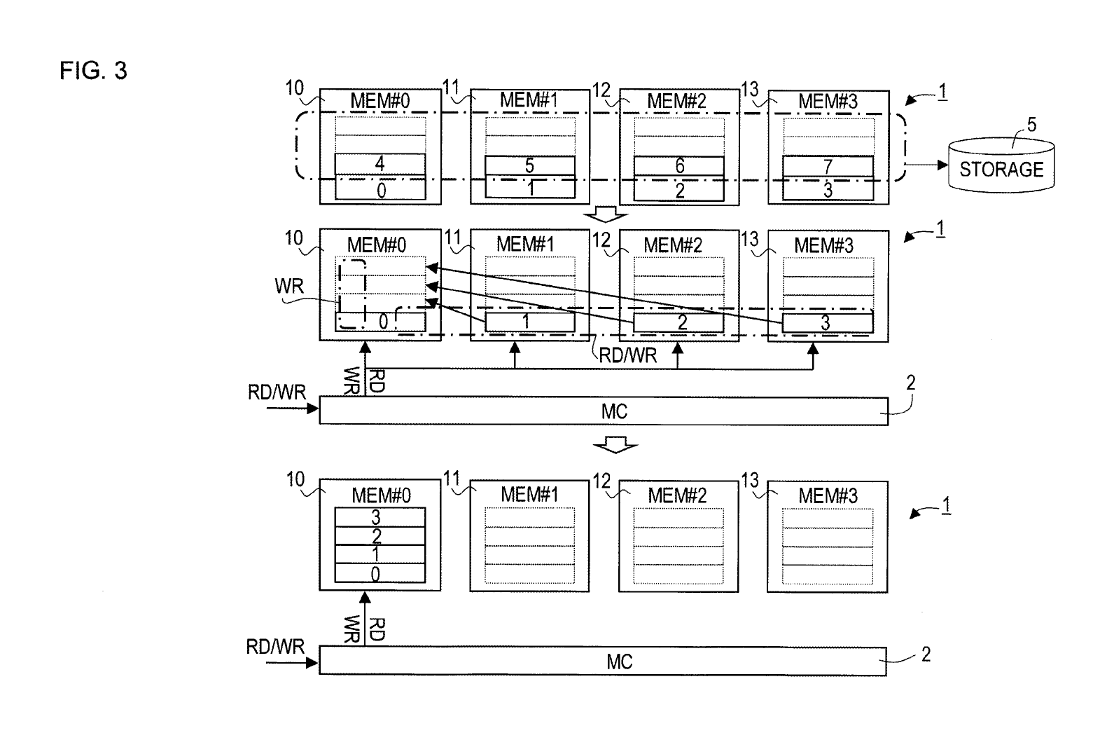

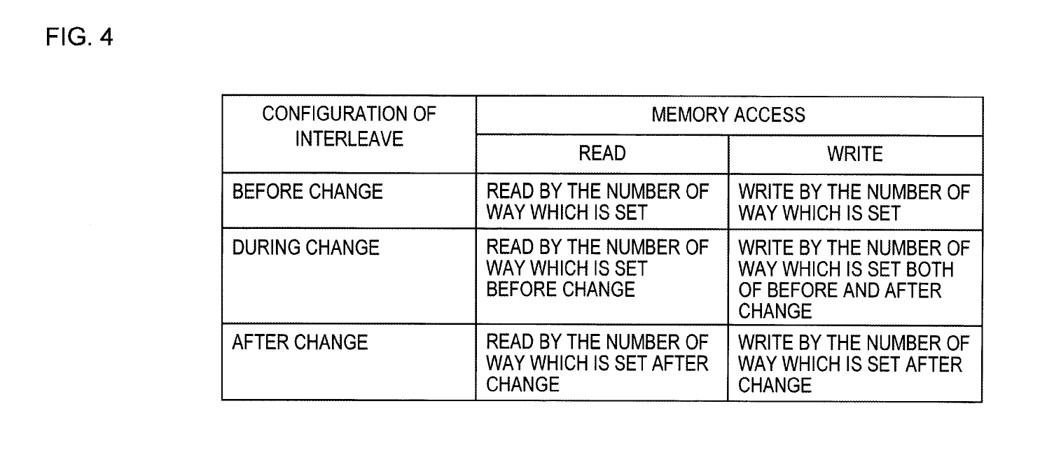

FIG. 2 is an explanatory diagram of the processing operation of an increase in the number of ways according to the embodiment. FIG. 3 is a diagram for explaining the operation of the process of an decrease in the number of ways according to the embodiment. FIG. 4 is an explanatory diagram of a memory access operation before change, during the change and after the change of the interleaving configuration according to the embodiment.

The process of increasing the number of ways according to the embodiment will be described by using FIG. 2 and FIG. 4. As illustrated as FIG. 2, the memory access control circuit 2 has a four ports and each of the ports connects to memory module group 10, 11, 12, 13, for example. In FIG. 2, the memory module group 10, 11, 12, 13 are marked by symbols MEM #0, MEM # 1, MEM # 2 and MEM # 3. However, the number of memory modules is not limited to four and may be more than one.

An example to increase the number of interleave from 1 way to 4 way will be explained by using FIG. 2. However, it can also be applied to change the number of interleave from n number of Way (n=integer and n>=1) to m number of way (m=an integer and m>1). As depicted by FIG. 2, each of the memory module group 10, 11, 12 and 13 is operating by 1 way, respectively. Therefore, as represented by the interleave configuration before change in FIG. 4, each of the memory module group 10, 11, 12, 13 is accessed for read and write by the number of way which is set. In the example, since the number of way is one, each of the memory module group 10, 11, 12, 13 is independently accessed for read and write.

When starting to change to 4 Way, the memory access control circuit 2 saves data (an area within dashed line in FIG. 2) held in the memory module group 11, 12, 13 (MEM # 1, MEM # 2, MEM # 3) to the storage apparatus 5 in accordance with an instruction from OS (Operating System) which will be described later. And, the OS prohibits the memory access to the address which has saved from the outside.

After save operation of the data to the storage apparatus 5 is completed, the OS instructs data copy to the memory access control circuit 2. The memory access control circuit 2 copies data held in the memory module group 10 to the memory module group 11, 12, 13. In FIG. 2, the memory module group 10 holds four data “0”, “1”, “2”, “3”, for example. The memory access control circuit 2 copies the data “1” held in the memory module group 10 to the memory module group 11, the data “2” held in the memory module group 10 to the memory module group 12, the data “3” held in the memory module group 10 to the memory module group 13.

During the configuration change of the memory (from a start of data save to copy completion), the read request “Rd” from the external is accepted for only the memory module group 10. The memory access control circuit 2 reads data from the memory module group 10 by 1 way for the read request “Rd”.

When the external read access will be allowed to the memory module group 11, 12, 13, there is a possibility that the data in the memory module group 11, 12, 13 have become the data after copy, thereby correct data can not obtained by 1 Way. Thus, the read access to the memory module groups 11, 12, 13 is prohibited during the data copy. On the other hand, since data read is allowed in the memory module group 10 by 1 Way, it is possible to use of one portion of the memory 1 during the configuration change of the memory.

In addition, during the configuration change of the memory, for the write request “Wr” from the outside, the memory access control circuit 2 writes write data to the memory module group 10 by the number of way (1 way) before the configuration change, and writes write data to the memory module group 10, 11, 12, 13 by the number of way (4 way) after the configuration change. When the write data is not written to the memory module group 11, 12, 13 and the write data is written to only the memory module group 10, there is a possibility that the write data will be lost in a case that the data in the memory module group 11, 12, 13 was data after copy, because the copy was completed.

When the write data is not written to the memory module group 10 by 1 way and the write data is written to the memory module group 10, 11, 12, 13 by 4 way, there is a possibility that the write data written in the memory module group 11, 12, 13 will be lost by the copy in a case that the data in the memory module group 11, 12, 13 was data before copy, even though the write data is written to the memory module group 11, 12, 13, because the copy was not completed. Therefore, since the data write is allowed to the memory module group 10 by 1 Way, it is possible to use of one portion of the memory 1 during the configuration change of the memory.

That is, as indicated by during change of the interleaved configuration in FIG. 4, for read access, the memory module group is read according to the number of way before the change. In addition, for write access, the memory module group is written in both the number of way before and after the change. Therefore, without affecting the operation of the configuration change, it is possible to correctly perform the read and write access.

When the copy of data from the memory module group 10 to the memory module group 11, 12, 13 has completed, the memory access control circuit 2 switches to interleave operation of 4 way for subsequent memory access. That is, by resuming the memory access to the memory module group 11, 12, 13 which had been stopped, the memory access is switched to the interleave operation of 4 Way. This allows high-speed memory access.

In addition, the data of the memory module group 11, 12, 13 which was saved to the storage apparatus 5 are written to the memory module group 10, 11, 12, 13 in 4 way as same manner, when the OS determines the necessity.

An example to decrease the number of interleave from 4 way to 1 way will be explained by using FIG. 3. However, it can also be applied to change the number of interleave from m number of Way (m=integer and m>1) to n number of way (n=an integer and n>=1). As depicted by FIG. 3, the memory module groups 10, 11, 12 and 13 are operating by 4 way. Therefore, as represented by the interleave configuration before change in FIG. 4, each of the memory module group 10, 11, 12, 13 is accessed for read and write by the number of way which is set. In the example, since the number of way is four, each of the memory module group 10, 11, 12, 13 is parallel accessed for read and write.

When starting to change to 1 Way, the memory access control circuit 2 saves data (an area within dashed line in FIG. 3) except the data (“0”, “1”, “2” and “3” in FIG. 3), which is converted the configuration at one time, the among the data held in the memory module groups 10, 11, 12, 13 (MEM # 0, MEM # 1, MEM # 2, MEM # 3) to the storage apparatus 5 in accordance with an instruction from OS (Operating System) which will be described later. And, the OS prohibits the memory access to the address which has saved from the outside. the MEM # 3), an area in dashed line held data held data to be converted composed of one in the figure (other than “0”, “1”, “2”, “3”) in the figure (saved in the storage device 5). And, OS prohibits the memory access from the outside to the address you have just saved.

After save operation of the data to the storage apparatus 5 is completed, the OS instructs data copy to the memory access control circuit 2. The memory access control circuit 2 copies the data “1”, “2” and “3” held in the memory module groups 11, 12 and 13 to the memory module group 10.

During the configuration change of the memory (from a start of data save to copy completion), the memory access control circuit 2 reads data from the memory module groups 10, 11, 12, 13 by the number of way before the change (4 Way in this case) for the read request “Rd” from the external.

When allowing the external read access by the number of way after change (1 way in this case), there is a possibility that the data in the memory module group 10 is data before copy, thereby a normal data can not be obtained by 1 way. On the other hand, since allowing the data read from the memory module groups 10˜13 by 4 Way, it is possible to use of one part of the memory 1 during the configuration change.

In addition, during the configuration change of the memory, for the write request “Wr” from the outside, the memory access control circuit 2 writes write data to the memory module group 10 by the number of way (1 way) after the configuration change, and writes the write data to the memory module groups 10, 11, 12, 13 by the number of way (4 way) before the configuration change. When the write data is not written to the memory module group 11, 12, 13 and the write data is written to only the memory module group 10 by 1 way, there is a possibility that the write data will be lost in a case that the data in the memory module group 11, 12, 13 was data before copy, because previous data in the memory module groups 11, 12, 13 are copied to the memory module group 10 even though the write data is written to the memory module group 10 by 1 way.

Further, when the write data is not written to the memory module group 10 by 1 way and the write data is written to the memory module group 10, 11, 12, 13 by 4 way, there is a possibility that the write data can not be held in the memory module group 10 by 1 way in a case that the data in the memory module group 11, 12, 13 was copied, because the data in the memory module groups 11, 12, 13 has been copied even though the write data is written to the memory module groups 10, 11, 12, 13 by 4 way. Therefore, since the data write is allowed to the memory module groups 10, 11, 12 and 13 by both of 1 Way and 4 Way, it is possible to use of one portion of the memory 1 during the configuration change of the memory.

That is, as indicated by during change of the interleaved configuration in FIG. 4, for read access, the memory module group is read according to the number of way before the change. In addition, for write access, the memory module group is written in both the number of way before the change and the number of way after the change. Therefore, without affecting the operation of the configuration change, it is possible to correctly perform the read and write access.

When the copy of data from the memory module groups 10˜13 to the memory module group 10 has completed, the memory access control circuit 2 switches to interleave operation of 1 way for subsequent memory access. That is, by stopping the memory access to the memory module group 11, 12, 13, the memory access is switched to the interleave operation of 1 Way. It is realized to perform the memory access which is reduced the power consumption.

In this way, it is possible that configuration of the interleaving dynamically change without restarting the system. Also, since the access of the memory is allowed during the change in the configuration of the memory, the dynamic change is possible without reducing the access performance relatively. Therefore, because the dynamic change (Hot Add/Hot Remove) of the memory which is set the interleaving is realized, it is possible to optimize memory resources (power/performance/volume) during system operation.

For example, when increasing the number of ways that can be used by the Hot Add of the memory, etc., by increasing the number of ways of the interleaving, it is possible to speed up memory access. Further, when the memory access speed is in excess or the amount of memory has become excessive, the number of ways of interleaving is decreased. Therefore, it is possible to reduce power consumption of the memory accesses by performing to turn of the power to the excessive memory module (Hot Remove).

(Memory Access Control Circuit)

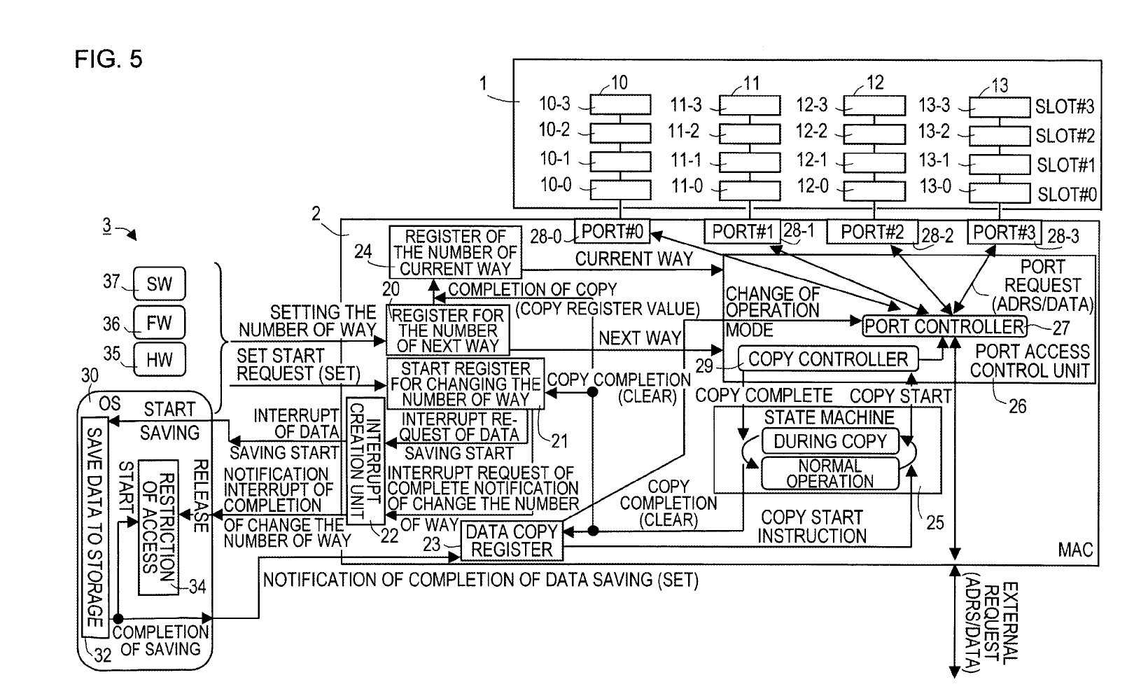

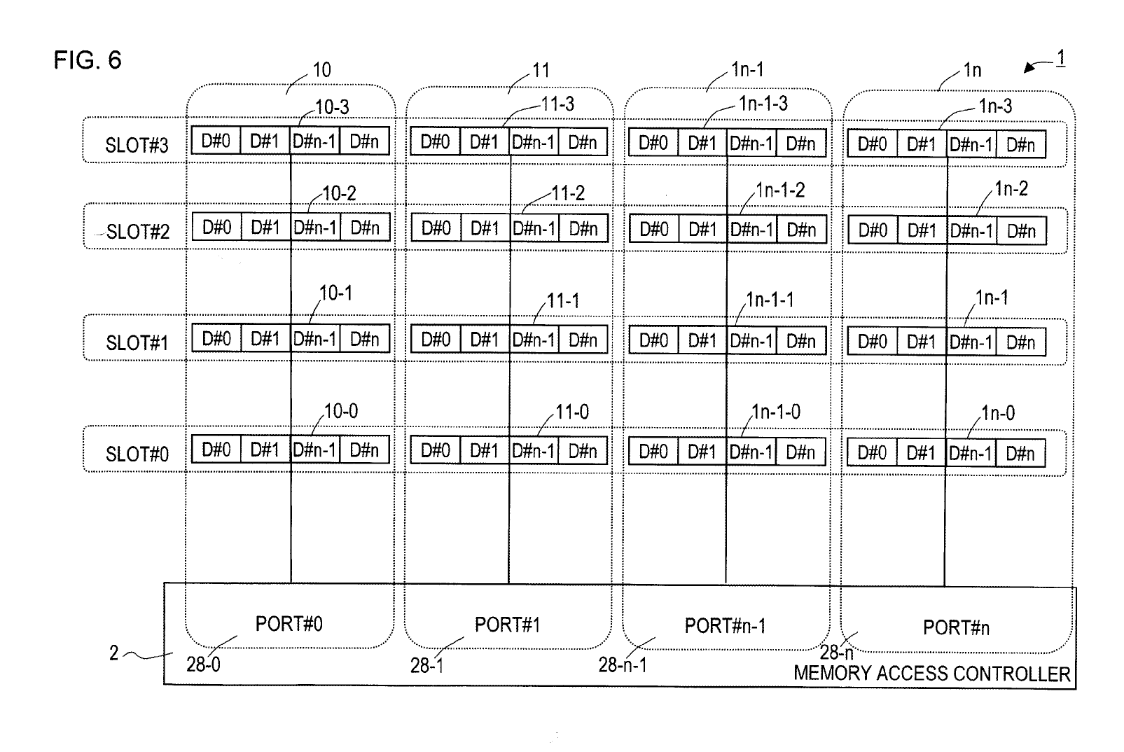

FIG. 5 is a block diagram of a computer system including the memory access control circuit according to the embodiment. FIG. 6 is a block diagram of the memory and the memory access control circuit in FIG. 5. In FIG. 5, same elements as that described in FIG. 1 to FIG. 3, are indicated by same symbols. As represented by FIG. 5, the memory access control circuit 2 includes a plurality of ports 28-0, 28-1, 28-2, 28-3, a port access controller 26 and a state machine 25.

The memory 1 includes memory module groups 10, 11, 12, 13 which are connected to the ports 28-0˜28-3 respectively. The memory 1 will be explained with reference to FIG. 6. In addition, FIG. 6 represents the memory 1 which includes n+1 pieces of ports 28-0˜28-n and n+1 pieces of memory module groups 10˜1n, for example. FIG. 5 represents an example that “n+1” in FIG. 6 is four. Accordingly, the number of ports and the number of memory modules are not limited to “4” in FIG. 5, and may be adapted other plural number.

The memory module group 10 includes L number of memory module 10-0˜10-3 (L is four in FIG. 5 and FIG. 6) which are connected in series to the port 28-0. Further, the memory module group 11 includes L number of memory module 11-0˜11-3 (L is four in FIG. 5 and FIG. 6) which are connected in series to the port 28-1. In below, as same as the memory module groups 10 and 11, the memory module group 1n includes L number of memory module 1n-0˜1n-3 (L is four in FIG. 5 and FIG. 6) which are connected in series to the port 28-n.

The memory modules 10-0˜1n-0 are assigned a same slot address Slot #0. The memory modules 10-1˜1n-1 are assigned a same slot address Slot #1. The memory modules 10-2˜1n-2 are assigned a same slot address Slot #2. The memory modules 10-3˜1n-3 are assigned a same slot address Slot #3.

Each of the memory modules 10-0˜1n-3 hold n pieces of data D#0˜D#n. In other words, an access unit of the memory modules 10-0˜1n-3 is the data D#0˜D#n. Thus, the data of each of the memory modules is defined by the port address P, the slot address S and the data address D. The memory modules 10-0˜1n-3 are constructed by the construction that can be plugged and unplugged to swapped to and from the slot of block of the memory 1, preferably. For example, the memory module is constructed by DIMM (Dual Inline Memory Module).

Returning to FIG. 5, the port access controller 26 includes a port control unit 27 and a copy control unit 29. The port control unit 27 receives an external request, creates a port request from a request address (a cache line) of the external the current number of ways, and dispatches the port request to each of the ports 28-0˜28-3. As described below, this port request includes the port address P, the slot address S and the data address D.

Further, the port control unit 27 receives write data, divides the write data according to the number of ways, and transmits the divided data to each of the ports 28-0˜28-3 when the request is a write request. In addition, the port control unit 27 assembles read data from the ports 28-0˜28-3 into one data and transmits the one data to the external.

The copy control unit 29 issues a copy request to the port control unit 27 in response to a copy start instruction. The state machine 25 controls the state of the port access control unit 26. In the embodiment, the state machine 25 controls to switch between normal operation and on copy.

In addition, the memory access control circuit 2 includes a Next Way register 20, a start register for changing the number of way 21, an interrupt generation unit 22, a data copy register 23 and a Current Way register 24. These registers 21, 22 and 23 are used for synchronization of saving and copying operation to the OS 30. The Next Way register 20 holds the number of way after the change, and notifies the number to the port access control unit 26. The start register for changing the number of way 21 holds a setting start request from the CPU 3, which will be described later, issues an interrupt request of start data saving, and issues an interrupt request of completion notification for changing the number of the way according to a completion of the copy.

The interrupt generating unit 22 connects to the start register for changing the number of way 21, and issues the interrupt of the data saving start and the interrupt of a completion notification for changing the number of way to the OS 30, which will be described later. The data copy register 23 holds a saving completion notification of data from the OS 30, and transmits an instruction to start copying to the state machine 25. The Current Way register 24 holds the current number of way of the port access control unit 26.

The CPU 3 has a HW (hardware) 35. The CPU 3 runs the OS30, and executes a FW (firmware) 36 and a SW (software) 37 under a control of the OS 30. The OS 30 has a data saving process 32 and an access restriction process 34. The data saving process 32 is a process to save the data in the memory 1 to the storage device 5, as described by FIG. 2 and FIG. 3. The access restriction process 34 is a process to restrict access of the save area in the memory 1, as described in FIG. 2 and FIG. 4.

(Changing Process of the Number of Interleaved Way)

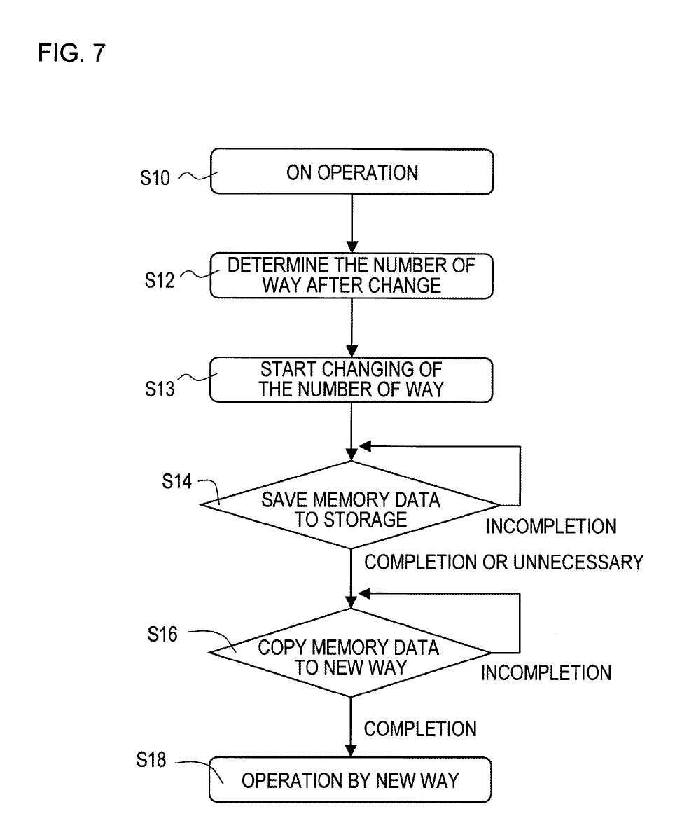

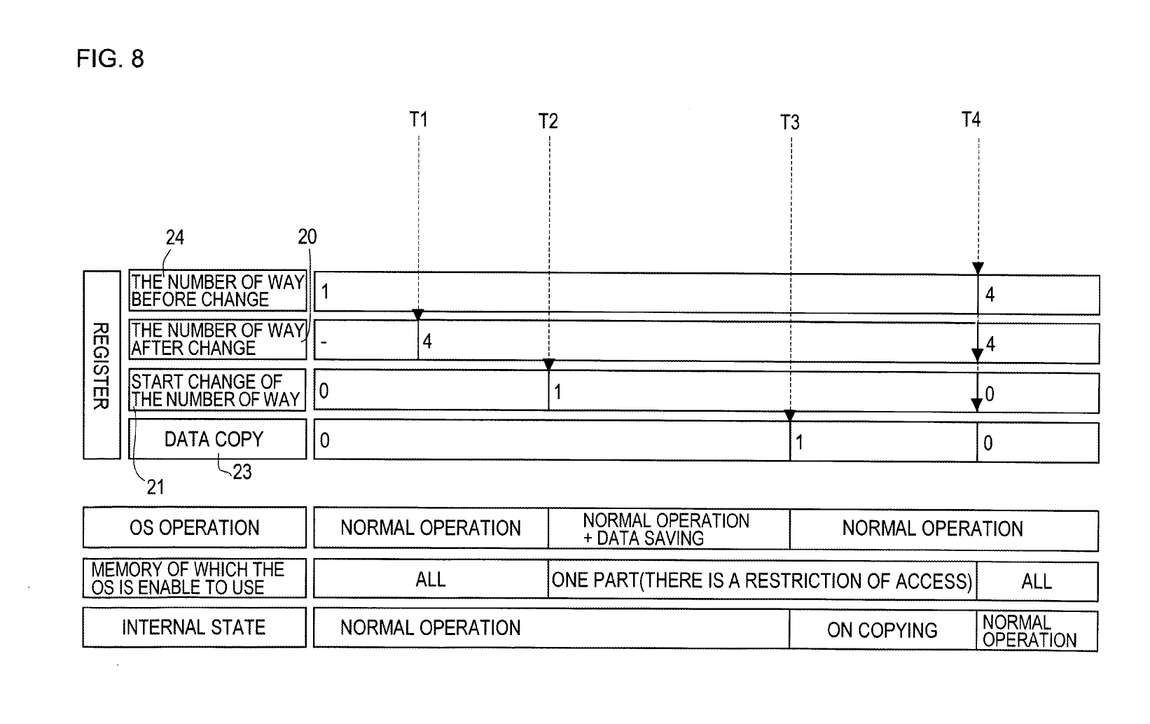

FIG. 7 is a flow diagram of the changing process of the number of interleaved way according to the embodiment. FIG. 8 is a diagram illustrating the transitions of data in the registers, the operation of the OS, available memory for the OS, and the internal state. Referring to FIG. 8, the changing process of the number of interleaved ways according the embodiment will be explained by FIG. 7.

(S10) The computer system is in an operation mode. For example, the hardware 35 in the CPU 3 is running the firmware 36 and the software 37 under the control of the OS 30, and reads and writes the memory 1. In FIG. 8, the memory access is in 1 Way which is the number of way before the change, and the OS 30 performs a normal operation. In addition, the available memory of which the OS 30 can use is the entire memory 1, and the internal state of the memory access control circuit 2 is a normal operation.

(S12) When the state, which starts the change of the number of way, has occurred during this operation, the number of way after the change is determined. Places to detect the state may be any of the OS 30 itself, the firmware 36, the software 37 and the hardware 35. For example, when Hot Add of the memory modules is carried out during the operation, the hardware 35 detects the additional memory module. The hardware 35 determines the number of way in order to use the additional memory module, and sets the number of the way after change to the Next Way register 20. In FIG. 8, at time T1, the hardware 35 sets the number of way after the change to the Next Way register 20. In the embodiment, the number of way after the change is determined to be “4”, and is set to the Next Way register 20.

(S13) Next, the portion which detects the state of change of the number of Way (for example, the hardware 35) sets a start request of setting to the start register 21 for changing the number of way. In FIG. 8, at time T2, the hardware 35 sets “1” (start of setting) to the start register 21 for changing the number of way. In response to set of the start request of the setting, the interrupt generation unit 22 issues an interrupt to start of saving data to the OS 30.

(S14) In response to the interrupt to start of saving data, the OS30 starts the data saving process 32. In other words, the OS 30 determines the save area from the number of way before the change and the number of way after the change, and issues a read request to the address of the save area to the port access control unit 26, as an external request. As illustrated in FIG. 8, because the internal state in the port access control unit 26 is continuing the normal operation, the port access control unit 26 reads the save area which is specified in the memory 1 in accordance with the read request of the save area from the OS 30. The OS 30 writes the data which is read from the save area into the storage device 5. Further, the OS 30 did not use the area in the memory 1 which is saved data yet when changing the number of way, the data saving is not necessary. That is, when it is judged that the OS 30 did not use the area to be saved data, the OS 30 determines that the data saving process is unnecessary.

(S16) When the saving process was completed or is determined unnecessary, the OS 30 starts the access restriction processing 34, and sets the start copy to the data copy register 23. Thus, the state machine 25 switches from the normal operation to in-copying operation, and issues an instruction to start copying to the port access control unit 26. In FIG. 8, at time T3 of which the data saving is completed, the internal state of port access control unit 26 switches from the normal operation to in-copying operation. Also, the OS 30 will return to the normal operation. Thus, the port access control unit 26 performs a data copy in the memory 1 from the number of way before the change to the number of way after the change according to the copy instruction of the copy control unit 29. Also, the OS 30 performs the access restriction process 34 for the save area during the copy operation.

(S18) When the port access control unit 26 has completed a copy of the data, the port access control unit 26 notifies the completion of the data copy to the state machine 25. As represented by time T4 in FIG. 8, the state machine 25 switches from the in-copying to the normal operation, and clears the start register 21 for changing the number of way to “0” according to the completion of the copy. By clearing the start request of the setting, the interrupt generation unit 22 issues the interrupt of the changing completion of the number of way to the OS 30. Further, according to the copy completion, the number of way which is set in the register 20 of the number of Next Way is set in the register 24 of the number of currently Way. That is, the number of current way in the port access control unit 26 is updated to the number of way after the change. As a result, the port access control unit 26 operates the access of the memory with the new number of way.

Because during the copy, for external read request, the memory read is performed by the configuration before changing the number of interleave, whereas for the external write request, the memory write is performed by both of the configurations before the change of the number of interleave and the configuration of the number of interleaving after the change, it is possible to dynamically change the configuration of the memory interleave without restarting the system. In addition, because during the change of configuration, the memory access is allowed, it is possible to dynamically change the configuration without lowering the performance relatively. Thus, it is possible to dynamically change the configuration of the memory (Hot Add/Hot Remove) which is set the interleaving, thereby it is possible to optimize memory resources (power/performance/volume) during system operation.

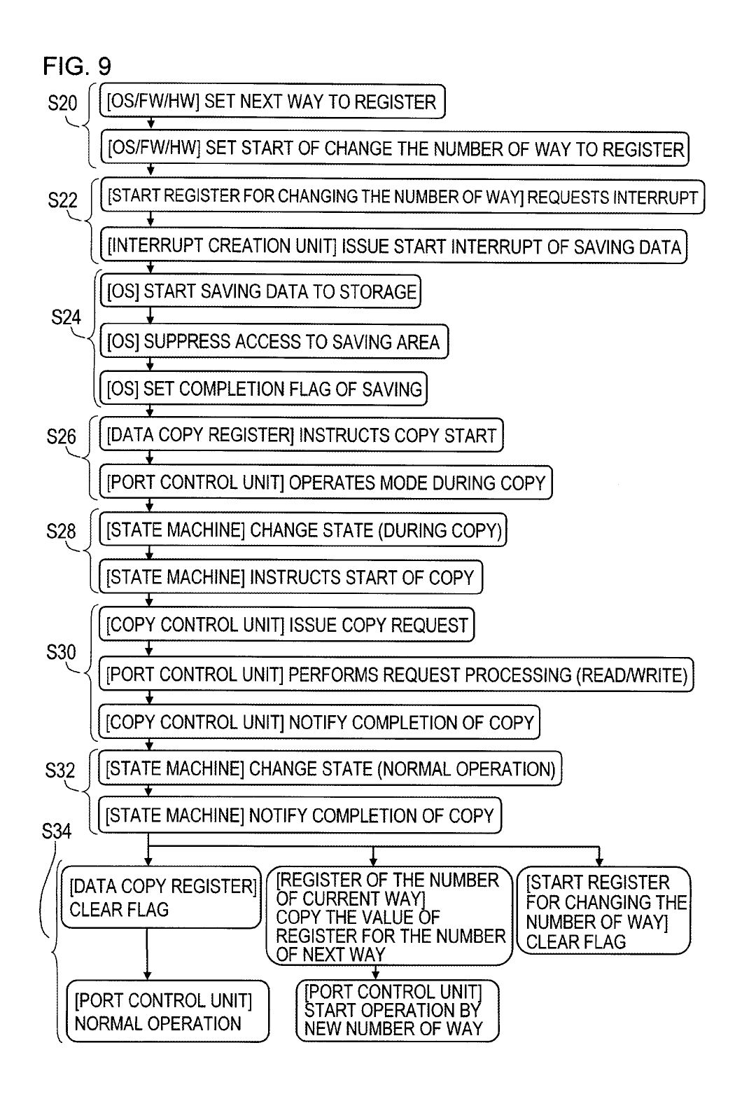

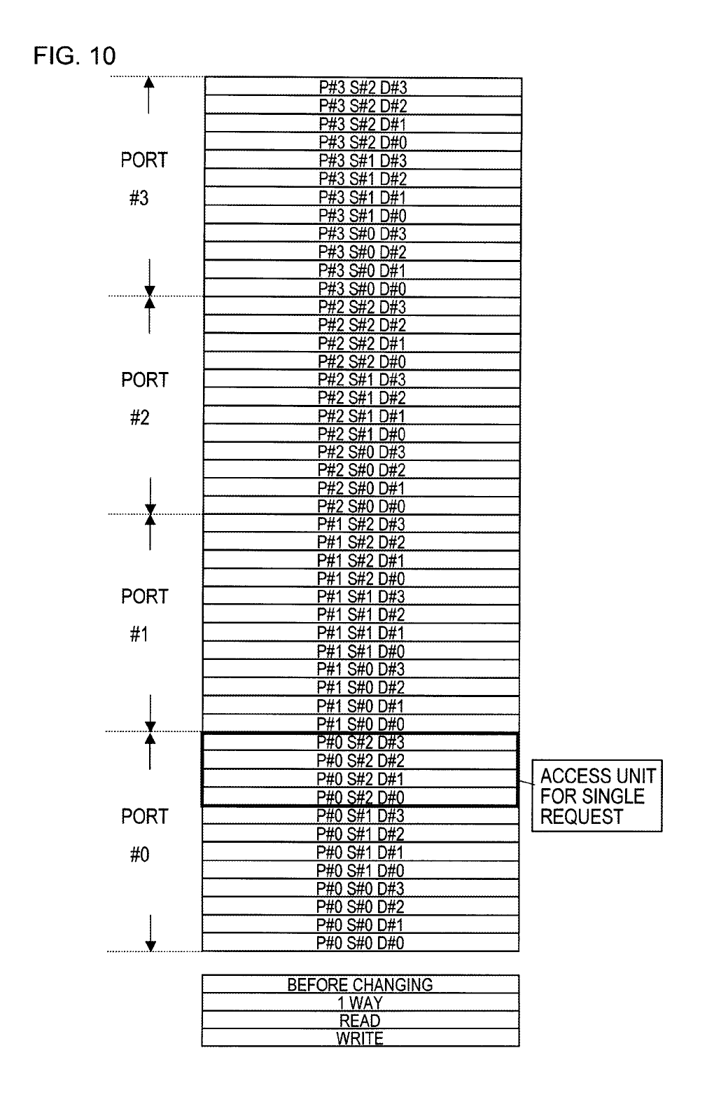

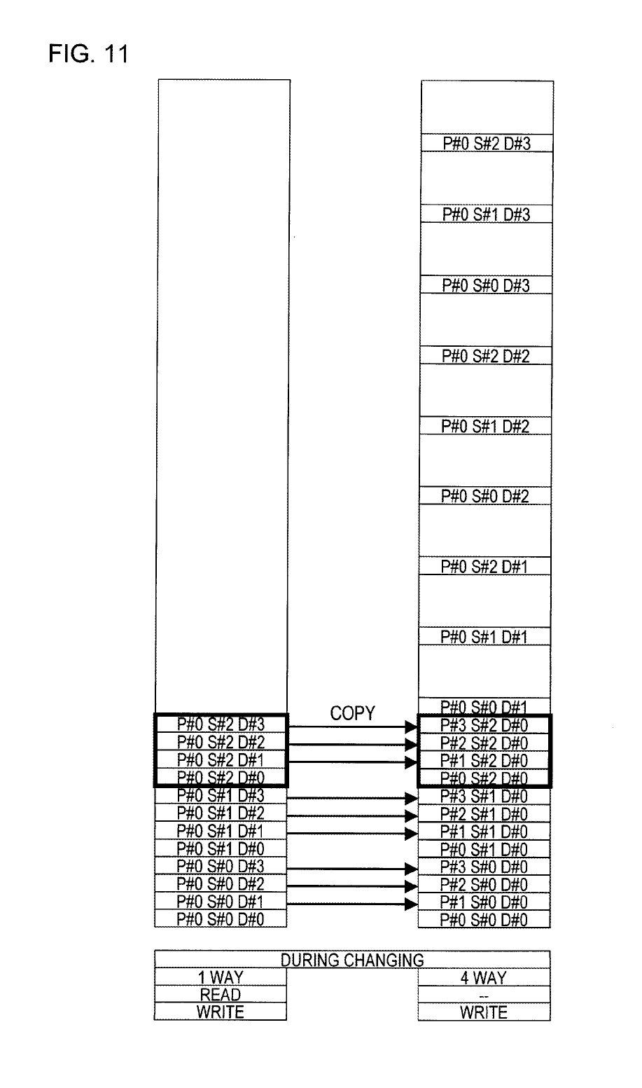

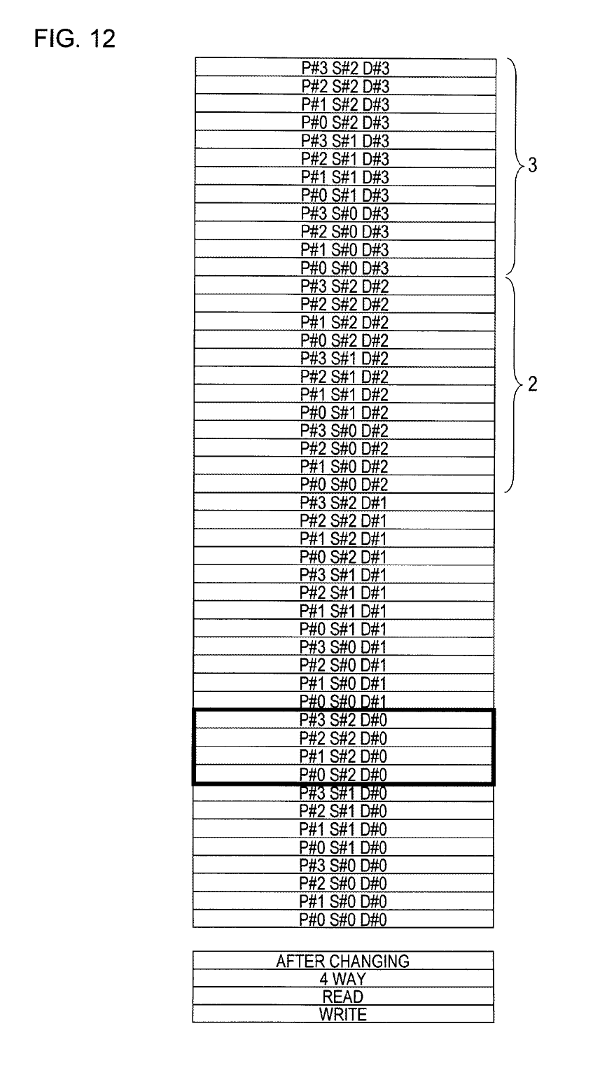

FIG. 9 is a more detailed process flow diagram of the processing in FIG. 7. FIG. 10 is an explanatory diagram of a memory map of the OS before the change of the number of way. FIG. 11 is an explanatory diagram of the memory map of the OS during the change of the number of way. FIG. 12 is an explanatory diagram of the memory map of the OS after the change of the number of way. Further, FIG. 10 to FIG. 12 represents the memory map of four memory module groups having four ports and three memory modules which is a configuration of the memory module described in FIG. 5 and FIG. 6, and depicts the port number to P#0˜P#3, the slot number to S#0˜S#2, and the data number to D#0˜D#3. In addition, FIG. 10˜FIG. 12 illustrate an example of configuration changes from 1 Way to 4 Way.

Hereinafter, the changing process of the number of interleaved way will be explained with reference to FIG. 5. FIG. 10˜FIG. 12.

(S20) At the start of change in the number of interleaved way, any one of the OS 30, the firmware 36 and the hardware 35 sets the number of Way after the change to the Next Way register 20, and sets a start request of the setting to the start register 21 for changing the number of way. Further, in the memory map of 1 Way before the change depicted by FIG. 10, the access unit of single request is each of data group D#0˜D#3 of each of the slot location S#0, S#1, S#2 of the port P#0. In other words, the state is a state of the number of interleaved 1 Way, as described in FIG. 2.

(S22) When the start request of the setting is set to the start register 21 for changing the number of way, the interrupt generation unit 22 issues an interrupt to start saving data to the OS 30.

(S24) In response to the interrupt to start saving the data, the OS 30 starts the data saving process 32. In other words, the OS 30 determines the save area from the number of way before the change and the number of way after the change, and issues a read request to the address of the save area to the port access control unit 26, as an external request. As illustrated in FIG. 8, because the internal state in the port access control unit 26 is continuing the normal operation, the port access control unit 26 reads the save area which is specified in the memory 1 in accordance with the read request of the save area from the OS 30. The OS 30 writes the data which is read from the save area into the storage device 5. Further, the OS 30 did not use the area in the memory 1 which is saved data yet when changing the number of way, the data saving is not necessary. That is, when it is judged that the OS 30 did not use the area to be saved data, the OS 30 determines that the data saving process is unnecessary.

When the OS 30 completed the saving process, the OS 30 starts the access restriction processing 34 which suppresses the access for the memory 1 which was assigned the saving address from the OS 30. And the OS 30 sets the completion of the data saving to the data copy register 23 and transmits the completion of data saving to the memory access control unit 2.

(S26) When the data copy register 23 is set the copy start, the operation mode of the port control unit 27 is switched to the in-copying mode.

(S28) Further, the data copy register 23 instructs the copy start to the state machine 25. Thus, the state machine 25 switches from the normal operation to in-copying operation, and issues an instruction to start copying to the copy control unit 29.

(S30) In response to change the state to in-copying, the copy control unit 29 issues the copy request to the port control unit 27. The port control unit 27 starts to copy the data, which remains in the memory 1 of which is operating by the number of way before the change registered in the current number of way register 24, to the memory 1 according to the number of way after the change registered in the register 20 of the number of Next Way. That is, the port control unit 27 reads the remaining data in the memory of which is operating by the number of way before the change and writes to the memory 1 according to the number of way after the change registered in the register 20 of the number of Next Way.

As illustrated in the memory map of FIG. 11, by the copy, for example, data block of one unit of access by 1 Way (port P#0, slot S#2, and data D#0˜D#3) is changed to data block in one unit of access by 4 Way (port P#0˜P#3, slot S#2, data D#0) due to the change to the 4 Way.

In addition, in the embodiment, when there is an external request during the copy of the memory, the port control unit 27 restricts read and write access by both of the number of way before the change and the number of way after the change, as described in FIG. 2 to FIG. 4. In other words, the port control unit 27 reads the data from the memory which is set the number of way before the change for the read request. In addition, the port control unit 27 writes data to the memory which is set both of the number of way before change and the number of way after the change for the write request. When the copy is complete, the copy control unit 29 notifies the completion of the copy to the state machine 25.

(S32) In response to the complete notification of the copy from the copy control unit 29, the state machine 25 returns to the normal operation state from the state during the copy. The state machine 25 issues a complete notification of the copy.

(S34) In response to the complete notification of the copy, value in the register of the number of Next Way 20 is copied to the current number of way register 24. In addition, in response to the complete notification of the copy, the flags in the data copy register 23 and the start register 21 for changing the number of way are cleared. When the flag in the data copy register 23 is cleared, the operation mode of the port control unit 27 switches from the read/write request operation of which the mode is being copied to the memory access operation (the normal operation) by the normal operation of the number of way after changing stored in the current number of way register 24.

Also, when the flag in the start register 21 for changing the number of way is cleared; the interrupt generation unit 22 notifies the interrupt to the OS 30 to notify the completion of preparation for changing the number of way. When the OS 30 is notified the completion of preparation for changing the number of way, the OS 30 release an address which has been suppressed to access, and the interleaved operation of the number of way after the change is initiated. That is, as depicted by FIG. 12, the memory map is changed to read and write a block of one unit of access 4 Way (port P#0˜P#3, slot S#2, the data D#0).

### Other Embodiments

In the above embodiment, an example has been described in a case that the OS 30 performs the access restriction for the save area, however the port access control circuit may perform the access restriction for the save area by an instruction of the OS. Further, it has been described that the port control circuit performs access control by the number of way before the change and the number of way after the change, as explained by FIG. 4, however OS 30 may also executes the access control. The number of divisions of the memory module groups and the number of divisions of the memory modules in the memory module group may be a plural and selected any number.

The foregoing has described the embodiments of the present invention, but within the scope of the spirit of the present invention, the present invention is able to various modifications, and it is not intended to exclude them from the scope of the present invention.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A memory access control device which performs read and write access by interleaving the memory having a plurality of memory circuits, the memory access control device comprising:
a plurality of ports that each connect to the plurality of memory circuits of the memory; and
a port access control circuit that reads or writes from and to the memory circuit via the plurality of ports in accordance with the number of ways of interleaving which is set for a request to the memory from an outside, and copies data on a location of the memory in a first configuration before changing the number of interleaved ways to a location of the memory in a second configuration after changing the number of interleaved ways according to an instruction of a change of the number of ways of interleaving,
wherein the port access control circuit, during the copying, reads the memory in the first configuration before changing the number of interleaved ways for a read request from said external, and writes the memory in both of the first configuration before changing the number of interleaved ways and the second configuration after changing the number of interleaved ways for a write requests from the external.

2. The memory access control device according to claim 1, wherein the port access control circuit starts the copy in response to the instruction of the change that the external device issues after reading data, which are not target of the change of the number of interleaved ways, in the memory and saving the data into a external storage device.

3. The memory access control device according to claim 1, wherein the memory access control device further comprising:
a first register that holds the number of ways of a current interleaving; and
a second register that holds the number of ways of interleaving after change,
and wherein the port access control device updates the number of ways in the first register by the number of ways in the second register, depending on a completion of the copy.

4. The memory access control device according to claim 1, wherein the memory access control device further comprising a notification circuit that is set a start instruction of changing from the external device, and notifies a completion of the changing of the number of ways of the interleaving to the external device according to a completion of the copy from the port access control circuit.

5. The memory access control device according to claim 2, the memory access control device further comprising a second notification circuit that is set a notification of saving completion of the data from the external device and instructs a change an operation mode from a normal mode to a copy mode to the port access control circuit.

6. The memory access control device according to claim 1, wherein the port access control circuit comprising:
a copy control unit that issues a copy request which copies data on a location of the memory in the first configuration before changing the number of ways in the interleaving to a location of the memory in the second configuration after changing the number of the ways in the interleaving in accordance with the instruction of the change of the number of ways of interleaving; and
a port control unit that reads or writes the memory via the plurality of ports according to the number of ways of interleaving which is set, for the request from the external in a normal mode, and during the copying, reads the memory in the first configuration before changing the number of interleaved ways for the read request from said external, and writes the memory in both of the first configuration before changing the number of interleaved ways and the second configuration after changing the number of interleaved ways for the write requests from the external.

7. A computer system comprising:
a processing unit;
a memory having a plurality of memory circuits;
a plurality of ports that each connect to the plurality of memory circuits of the memory; and
a port access control circuit that reads or writes from and to the memory circuit via the plurality of ports in accordance with the number of ways of interleaving which is set for a request to the memory from an outside, and copies data on a location of the memory in a first configuration before changing the number of interleaved ways to a location of the memory in a second configuration after changing the number of interleaved ways according to an instruction of a change of the number of ways of interleaving,
wherein the port access control circuit, during the copying, reads the memory in the first configuration before changing the number of interleaved ways for a read request from said external, and writes the memory in both of the first configuration before changing the number of interleaved ways and the second configuration after changing the number of interleaved ways for a write requests from the external.

8. The computer system according to claim 7, wherein the processing unit reads data, which are not target of the change of the number of interleaved ways, in the memory, saves the data into an external storage device and issues the instruction of the change of the number of ways of the interleaving after completing the save.

9. The computer system according to claim 7, wherein the computer system further comprising:
a first register that holds the number of ways of a current interleaving; and a second register that holds the number of ways of interleaving after change,
and wherein the port access control device updates the number of ways in the first register by the number of ways in the second register, depending on a completion of the copy.

10. The computer system according to claim 7, wherein the computer system further comprising a notification circuit that is set a start instruction of changing from the processing unit, and notifies a completion of the changing of the number of ways of the interleaving to the processing unit according to a completion of the copy from the port access control circuit.

11. The computer system according to claim 10, wherein the notification circuit issues a start request of saving data to the processing unit in response to a set of an instruction to start setting change from the processing unit,
and wherein the processing unit starts a process of reading the data which are not target to the change in the number of ways of interleaving of the memory in response to the start request of saving data and saving the data in the external storage device.

12. The computer system according to claim 10, wherein the processing unit starts a process of saving in accordance with the start request of saving data from the notification circuit, and prohibits the memory access of the data that is not target to change in the number of ways of interleaving in the memory.

13. The computer system according to claim 8, wherein the computer system further comprising a second notification circuit that is set a notification of saving completion of the data from the processing unit and instructs a change an operation mode from a normal mode to a copy mode to the port access control circuit.

14. The computer system according to claim 7, wherein the port access control circuit comprising:
a copy control unit that issues a copy request which copies data on a location of the memory in the first configuration before changing the number of ways in the interleaving to a location of the memory in the second configuration after changing the number of the ways in the interleaving in accordance with the instruction of the change of the number of ways of interleaving; and
a port control unit that reads or writes the memory via the plurality of ports according to the number of ways of interleaving which is set, for the request from the external in a normal mode, and during the copying, reads the memory in the first configuration before changing the number of interleaved ways for the read request from said external, and writes the memory in both of the first configuration before changing the number of interleaved ways and the second configuration after changing the number of interleaved ways for the write requests from the external.
